(19) United States
(12) Patent Application Publication
(10) Pub. No.: US 2025/0376257 A1
(43) Pub. Date: Dec. 11, 2025

(54) METHOD FOR CONTROLLING FLIGHT COMMANDS OF AN AIRCRAFT, FLIGHT-COMMAND CONTROLLER DEVICE, AND AIRCRAFT

(71) Applicant: Airbus Operations (S.A.S.), Toulouse (FR)

(72) Inventors: Guillaume Lehmann, Toulouse (FR); Mehieddine Khennoussi, Toulouse (FR)

(21) Appl. No.: 19/218,817

(22) Filed: May 27, 2025

(30) Foreign Application Priority Data
Jun. 5, 2024 (FR) FR2405926

(51) Int. Cl. B64C 13/18; B64C 13/50

(52) U.S. Cl. CPC B64C 13/18; B64C 13/503; B64C 13/506

(57) ABSTRACT

An automated upset-recovery method for recovering an aircraft into a normal flight envelope after detection of one or more flight parameters or one or more flight conditions of the aircraft outside a flight envelope peripheral to the normal flight envelope and on the basis of adapted information coming from sensors and or one or more computers of the aircraft, which are configured to deliver information representative of flight conditions of the aircraft, by carrying out automated control of flight commands.

### TECHNICAL FIELD

The disclosure herein relates to an automated upset-recovery method for recovering the flight of an aircraft into a normal flight envelope or into a peripheral flight envelope in the event of significant disturbances to the flight, and to a flight-command controller device configured to carry out this method, and to an aircraft comprising such a flight-command controller device.

### BACKGROUND

Current aircraft are designed to fly normally in a flight envelope called the “normal flight envelope” in which commercial flights operated by airlines take place. A normal flight envelope is conventionally defined by boundaries determined on the basis of a set of flight parameters or flight conditions of the aircraft such as, by way of example, a minimum or maximum roll angle, a minimum or maximum pitch angle, a maximum angle of attack, a minimum or maximum speed for a given configuration of the aircraft, or a maximum altitude.

In modern aircraft, flight-command computers implement protection laws which aim to keep an aircraft within its normal flight envelope, whether the piloting is carried out manually or automatically. This is then a mode of operation of the flight-command computer according to command laws called normal laws. In command mode according to these normal laws, the protection laws implemented limit the instructions of a human pilot or of an autopilot so as to keep the airplane within its normal flight envelope. However, there is a mode of operation of the command computer, operating according to direct laws, in which all or some of the protection laws are deactivated and in which the control of the flight control surfaces then follows the instructions of a human pilot. To increase safety, it is very rare for a mode operating according to direct laws to be activated. In addition, in the event of’ external disturbances (gusts of wind, wake turbulence), the normal protection laws prevent the airplane from leaving its normal flight envelope. Nevertheless, it may happen that the intensity of a disturbance is such that the protection laws do not allow an aircraft to be kept within its normal flight envelope, but in a peripheral flight envelope, which is larger than its normal flight envelope, but which always guarantees that the airplane is kept in a healthy and safe situation. In this case, the flight commands according to the normal laws gradually carry out a return of the aircraft to its normal flight envelope.

Very exceptional circumstances, of meteorological origin or as a result of a collision, for example, could be of a nature to cause the aircraft to move outside its peripheral flight envelope (and therefore also its normal flight envelope). Such a situation is commonly referred to as “upset”. This situation corresponds, for example, to a roll angle the absolute value of which is greater than 125 degrees. In such a situation, the commands of the aircraft pass into a command mode according to the direct laws, so as to allow the pilot(s) to bring the aircraft back into its normal flight envelope without being constrained by protection laws. Such a maneuver for recovering an aircraft into a normal flight envelope is called “upset recovery”. The management of such a situation by a human pilot is demanding and represents a very substantial workload for this pilot who must then combine a number of precise actions while risking finding themselves in a situation of spatial disorientation.

The situation can be improved.

### SUMMARY

An object of the disclosure herein is to automate a recovery sequence which aims to bring an aircraft out of an “upset” situation so as to increase the safety of the flight and preserve the integrity of the aircraft.

To this end, the disclosure herein proposes an upset-recovery method for recovering an aircraft in flight into a first predefined flight envelope called the “normal flight envelope”, the method being executed in a flight-command control device and the method comprising:
i) recurringly obtaining first information coming from sensors and/or one or more computers of the aircraft, which are configured to deliver information representative of one or more flight parameters or one or more flight conditions of the aircraft,
ii) detecting one or more flight parameters or one or more flight conditions of the aircraft outside a second flight envelope of the aircraft, called the “peripheral flight envelope”, which is broader than the normal flight envelope and comprises the normal flight envelope,
iii) adapting the first information,
iv) automated control of flight commands of the aircraft on the basis of the adapted information, so as to recover the flight of the aircraft into the normal flight envelope.

The upset-recovery method according to the disclosure herein may further comprise the following optional features, considered alone or in combinations:
The adaptation of the first information comprises comparing each item of the first information with a range of acceptable values which is predefined in relation to the nature of the information in question and replacing the information in question with a substitution value when the information in question is outside the predefined range of acceptable values.
The substitution value is the last value measured prior to the detection of one or more flight parameters or one or more flight conditions outside the peripheral flight envelope, for the information in question.
The automated control of flight commands is carried out for a predetermined maximum duration from the detection of one or more flight parameters or one or more flight conditions of the aircraft outside a second flight envelope of the aircraft.
The aircraft is automatically configured into a direct-law flight-command mode at the end of the maximum duration if the aircraft is not recovered into the normal flight envelope.

Another object of the disclosure herein is a device for controlling flight commands of an aircraft, comprising electronic circuitry configured to:
i) recurringly obtain first information coming from sensors and/or one or more computers of the aircraft, which are configured to deliver information representative of one or more flight parameters of the aircraft or one or more flight conditions of the aircraft,
ii) detect one or more flight parameters of the aircraft or one or more flight conditions of the aircraft outside a second flight envelope of the aircraft, called the “peripheral flight envelope”, which is broader than the normal flight envelope and comprises the normal flight envelope,
iii) carry out adaptation of the first information,
iv) carry out automated control of flight commands of the aircraft on the basis of the adapted information, so as to recover the flight of the aircraft into the normal flight envelope.

The device for controlling flight commands of an aircraft according to the disclosure herein may further comprise the following optional features, considered alone or in combinations:
The flight-command control device further comprises electronic circuitry configured to carry out the adaptation of the first information by comparing each item of the first information with a range of acceptable values which is predefined in relation to the nature of the information in question and replacing the information in question with a substitution value when the information in question is outside the predefined range of acceptable values.
The flight-command control device further comprises electronic circuitry configured to define the substitution value as being the last value measured prior to the detection of one or more flight parameters or one or more flight conditions outside the peripheral flight envelope, for the information in question.
The flight-command control device further comprises electronic circuitry configured to carry out the automated control of flight commands for a predetermined maximum duration from the detection of one or more flight parameters or one or more flight conditions of the aircraft outside the second flight envelope of the aircraft.
The flight-command control device further comprises electronic circuitry configured to automatically configure the aircraft into a direct-law flight-command mode at the end of the maximum duration if the aircraft is not recovered into the normal flight envelope.

The disclosure herein further relates to an aircraft comprising at least one flight-command control device as described above.

Another object of the disclosure herein is a computer program product comprising program code instructions for executing the steps of a method as described above when this program is executed by a processor of a device for controlling flight commands of an aircraft.

Lastly, the disclosure herein relates to a storage medium comprising a computer program product as described above.

### BRIEF DESCRIPTION OF THE DRAWINGS

FIG. 1 illustrates an aircraft comprising at least one flight-command controller device according to one embodiment;

FIG. 2 schematically illustrates a flight-command control system comprising a flight-command controller device according to one embodiment;

FIG. 3 schematically illustrates an upset-recovery method for recovering an aircraft into its normal flight envelope according to one embodiment of the disclosure herein;

FIG. 4 schematically illustrates a variant of the upset-recovery method for an aircraft already shown in FIG. 3; and,

FIG. 5 schematically illustrates an internal architecture of the flight-command controller device already shown in FIG. 2.

### DETAILED DESCRIPTION

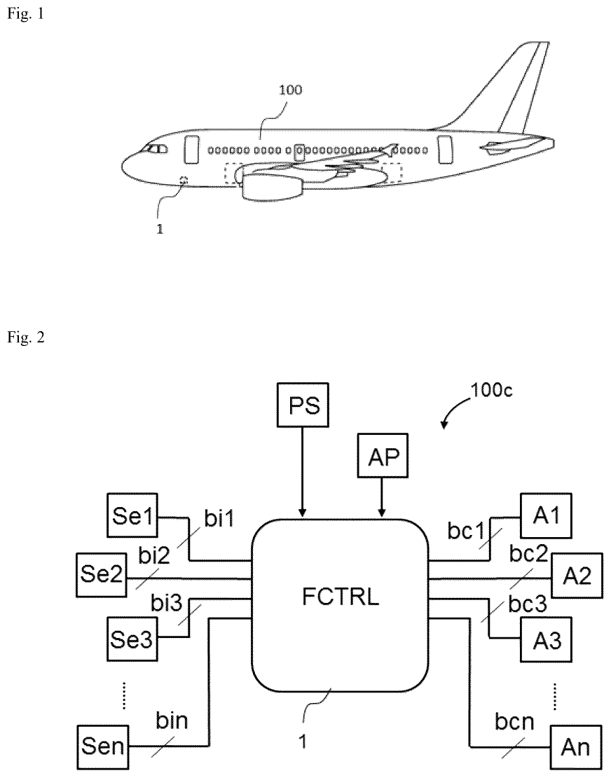

FIG. 1 schematically shows an aircraft 100 comprising an on-board flight-command controller device 1 connected to a plurality of sensors and/or computers Se1, Se2, Se3, . . . , Sn which are configured to deliver information representative of flight parameters and flight conditions of the aircraft 100. “Flight parameters” are to be interpreted here as information representative of setpoints entered into the systems of the aircraft 100, such as, for example, a heading setpoint, a rate-of-climb setpoint, an altitude or flight-level setpoint, etc. The examples given here are not limiting. “Flight conditions” are to be interpreted here as information representative of actual measured or detected conditions which reflect instantaneous conditions according to which the flight of the aircraft 100 is carried out or else the last conditions measured for all or some of the measured or considered quantities. These are, for example, the measured rate of climb, the corrected altitude, the measured ground speed, the measured angle of attack, the roll angle, the pitch angle, the yaw angle, etc. Here again, the examples cited here are not limiting.

FIG. 2 schematically shows a flight control system 100c of the aircraft 100 comprising the flight-command controller “FCTRL” 1 of an aircraft, connected on the one hand to sensors or computers Se1, Se2, Se3, . . . , Sen, and connected on the other hand to flight-command or control-surface actuators A1, A2, A3, . . . , An. The flight-command controller device 1 is furthermore connected to a stick or mini-stick management module PS comprising electronic circuitry configured to carry out scanning of piloting instructions received via at least one stick or mini-stick located in a cockpit of the aircraft 100, which stick or mini-stick is further configured to carry out flight commands manually under the control of a human pilot. The flight-command controller device is additionally connected to an autopilot module AP comprising electronic circuitry configured to carry out flight commands between two predefined points in space corresponding to a navigation instruction of the aircraft 100, for example according to a flight plan or on the basis of flight instructions which are predefined or entered via an interface for the input of air navigation parameters of the aircraft 100.

According to one example embodiment, a sensor Se1 is a differential pressure measurement sensor indicating an air speed of the aircraft which has the control system on board; a sensor Se2 is a pressure sensor delivering altitude information of the aircraft and an incidence (or angle-of-attack) sensor Se3, and a computer Sn is an internal computer of an inertial measurement unit of the aircraft delivering information on yaw angle, roll angle, pitch angle and acceleration in at least three orthogonal directions in pairs of a spatial reference frame defined with reference to the aircraft 100. The sensors Se1, Se2, Se3 and the computer Sen are described here by way of example and the aircraft 100 further comprises a very large number of other sensors Se4, Se5, Se6, . . . Sen-2, Sen-1, not being described here in greater detail insofar as this is not useful for understanding the disclosure herein, such as temperature sensors, pressure sensors, sensors for relative movements of the air on the fuselage, additional incidence sensors, radars, weather sensors, or one or more tracking and positioning modules of GPS type, these examples not being limiting. Still according to the example embodiment described, the actuator A1 is an actuator for commanding direction control surfaces of the aircraft, the actuator A2 is an actuator for commanding depth control surfaces of the aircraft, the actuator A3 is an actuator for commanding drag surfaces of the aircraft and the actuator An is a module for controlling the engine thrust of the aircraft. The actuators A1, A2, A3 and An are described here by way of example and the aircraft further comprises a very large number of other flight-command actuators A4, A5, A6, An-2, An-1, not being described here in greater detail insofar as this, here again, is not useful for understanding the disclosure herein, such as, for example, actuators for the deployment and retraction of landing gears, actuators for high-lift surfaces, actuators for de-icing airfoil elements, or actuators for engine-thrust reversers, these examples, here again, not being limiting. The sensors and/or computers Se1, Se2, Se3, . . . Sn are respectively connected to the flight-command controller device 1 via communication links bi1, bi2, bi3, . . . bin, respectively configured for the transmission of information i1, i2, i3, . . . in between each of the sensors or computers and the flight-command controller device 1. Thus, for example, the sensor Se1 delivers information i1 to the flight-command controller device 1 via the link bi1, the sensor Se2 delivers information i2 to the flight-command controller device 1 via the link bi2, and so on. According to one embodiment, the communication links bi1, bi2, bi3, . . . , bin are bidirectional communication buses and the flight-command controller device 1 is configured to address configuration or control messages to the various sensors Se1, Se2, Se3, . . . , Sen, in addition to the fact that it is configured to receive useful information coming from each of the sensors and/or computers Se1, Se2, Se3, . . . Sen. Similarly, the flight-command controller device 1 is connected to each of the actuators A1, A2, A3, . . . , An, respectively via a communication link bc1, bc2, bc3, . . . , bcn, configured to transmit command information c1, c2, c3, . . . , cn, respectively. Thus, the communication link bc1 carries command information, or commands, c1 between the flight-command controller device 1 and the actuator A1, the communication link bc2 carries command information, or commands, c2 between the flight-command controller device 1 and the actuator A2, and so on. According to one embodiment, the communication links bc1, bc2, bc3, . . . , bn are bidirectional communication buses and the flight-command controller device 1 is configured to address configuration or control messages to the various actuators A1, A2, A3, . . . , An, in addition to the fact that it is configured to send flight-command information to the actuators A1, A2, A3, . . . , An.

The flight-command controller device 1 is configured to sample and analyze, under conditions closest to real time, the information coming from all the sensors and/or computers Se1, Se2, Se3, . . . , Sen for the purpose of determining flight conditions or parameters of the aircraft 100 which has it on board and accordingly determining whether the aircraft 100 is moving within its normal flight envelope, within its peripheral flight envelope or else outside its normal envelope and outside its peripheral flight envelope. It should be noted that a flight of the aircraft 100 outside its peripheral flight envelope implies here a flight outside its normal flight envelope insofar as its peripheral flight envelope is larger than its normal flight envelope in the sense that it has boundaries which are further away than those of the normal flight envelope. In addition, the flight-command controller device 1 is configured to send flight-command information to the actuators A1, A2, A3, . . . , An in sequences which are predetermined or determined on-the-fly, as the case may be, so as to recover the aircraft into its peripheral flight envelope then into its normal flight envelope, in an automated manner. For example, the flight-command controller device 1 addresses flight-command information to the actuators in question for the purpose of positioning the airfoil of the aircraft flat, then for the purpose of obtaining an angle of attack in accordance with the peripheral flight envelope then the normal flight envelope of the aircraft 100. According to one embodiment, the flight-command controller device 1 sends flight-command information for a predetermined, fixed or adjustable, maximum duration Tmax at the end of which if the flight conditions of the aircraft 100 have not become compliant with the normal flight envelope again, the aircraft 100 is configured according to direct command laws on the basis of which the flight-command actuators of the aircraft 100 will be controlled according to instructions established by a human pilot. According to one embodiment, the predetermined maximum duration Tmax for which the flight-command control device 1 carries out or attempts to carry out upset recovery of the flight of the aircraft 100 according to its normal flight envelope or according to its peripheral flight envelope is between fifteen and sixty seconds, preferably thirty seconds.

According to one embodiment, the flight-command controller device 1 carries out adaptation of the information obtained i1, i2, i3, . . . , in from the sensors and/or computers Se1, Se2, Se3, . . . , Sen. Specifically, depending on the abnormal flight conditions, it is possible for some of the sensors to deliver meaningless information, in particular if the flight conditions are very far away from normal flight conditions in the normal flight envelope of the aircraft 100. For example, if the aircraft 100 were in a position which considerably disturbs the flow of air around one or more static pressure taps, altitude and speed information may not be representative of the actual quantities for altitude and speed in the air of the aircraft 100. Specifically, an aircraft sensor is designed and intended to carry out measurements and deliver information under predefined conditions, which have their own limits of use. Thus, a first adaptation of the information i1, i2, i3, . . . , in obtained by the flight-command controller device 1 consists in verifying whether the information i1, i2, i3, . . . , in obtained and representative of physical quantities to be measured is consistent and in particular if the transmitted values are each within a range of values or several ranges of values which are considered to comprise possible values or consistent values, and this for each of the sensors used or at the very least for each of the sensors identified as possibly disruptable under flight conditions outside the peripheral flight envelope and the normal flight envelope of the aircraft 100. According to one embodiment, a second adaptation of the information coming from the sensors and/or computers Se1, Se2, Se3, . . . Sn is carried out, which aims to analyze the consistency or the absence of consistency of the measured quantities as a function of the previously measured values for the same quantity. By way of example, if an altitude of the aircraft of 38000 feet is measured at a given time then this altitude is measured at 37800 feet two seconds later, the measurement appears consistent. Similarly, if an altitude of the aircraft of 14500 feet is measured at a given time then this altitude is measured at 14657 feet two seconds later, the measurement appears consistent here too. In contrast, if an altitude of the aircraft of 38000 feet is measured at a given time then this altitude is measured at 13780 feet two seconds later, there is a notable inconsistency in one or the other of these two measurements, or even in both measurements. According to one embodiment, when a measurement appears to be inconsistent, a value of the measured quantity which is determined as being inconsistent is replaced with a so-called substitution value. According to one embodiment, the substitution value is the last value measured and determined as being consistent. According to another embodiment, and as a function of the measured quantity, a substitution value can be predefined. For example, when a roll angle is measured with an angular reference set between −180° in the case, for example, of a rollover to the left of the aircraft 100, up to an angular reference set at +180° in the case, for example, of a rollover to the right of the aircraft 100, there must be no zero value between these two maximum values when the aircraft has its wings flat (horizontal) but is flying on its back; this would then be interpretable as an absence of roll angle and would therefore be an inconsistent value.

According to one embodiment, the flight-command controller device 1 further carries out adaptations to unusual attitude conditions of the aircraft 100. According to one example, and in the case of so-called longitudinal protections with an aircraft moving on its back, the sign and/or the amplitude of the pitch attitude and/or of the speed of the aircraft 100 should be adapted so as to take account of the unusual attitude of the aircraft, so that the commands sent to control surfaces of the aircraft act in the right direction compared to an aircraft under normal attitude conditions. According to the described example for which the aircraft 100 is moving on its back, when it is desired to decrease a speed of the aircraft in the air and considering a command defined in terms of load factor, a flight command should be established while seeking a load factor of less than −1 g to move the nose of the aircraft 100 upward in order to decrease the speed of the aircraft 100 in the air, while at normal attitude, a load factor of greater than 1 g should be sought so as to position the nose of the aircraft 100 upward and then decrease the speed of the aircraft 100 in the air.

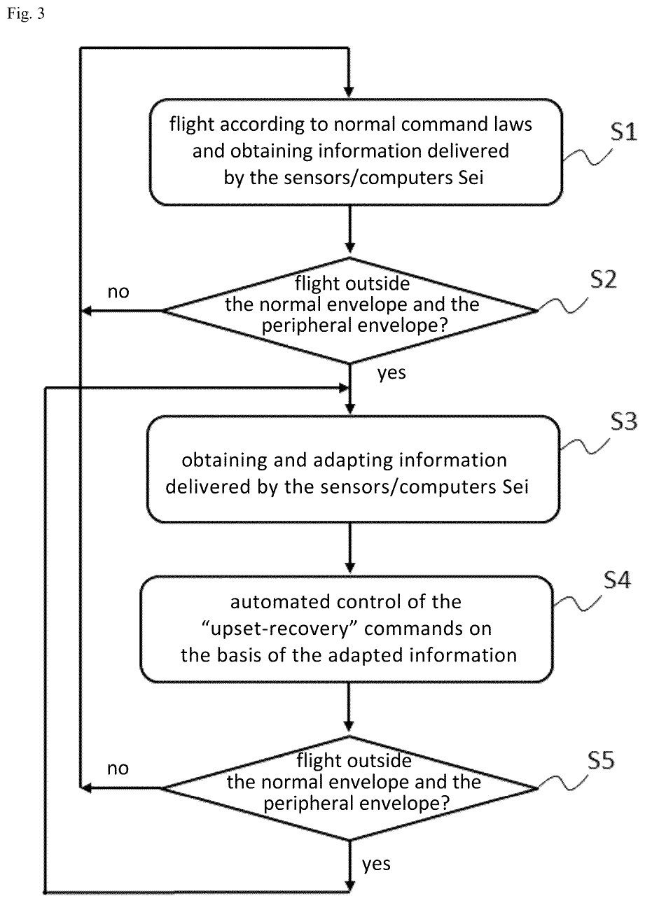

FIG. 3 schematically illustrates an upset-recovery method for recovering the flight conditions of an aircraft into its normal flight envelope, executed by the flight-command controller device according to one embodiment. According to the example described, this is the flight-command controller device 1 of the aircraft 100.

A step S1 is an initial or nominal step during which the aircraft 100 which has on board the system 100c previously illustrated in relation to FIG. 2 carries out a flight within the normal flight envelope of the aircraft 100 and according to normal command laws. Thus, during this step, the command information delivered by the flight-command controller device 1 to the various flight-command actuators and to the various control surfaces A1, A2, A3, . . . , An of the aircraft 100 is adjusted according to the protection laws of the normal command laws on the basis of the setpoints obtained by the sensors and/or computers Sei among Se1, Se2, Se3, . . . , Sen.

A step S2 corresponds to a test step which aims, if necessary, to carry out detection of one or more measured quantities and/or one or more flight parameters on the basis of the information obtained by the flight-command controller device 1, coming from sensors and/or computers Se1, Se2, Se3, . . . , Sn, corresponding to flight conditions outside the normal flight envelope and the peripheral flight envelope of the aircraft 100. For example, an air speed that is too low or else an air speed that is too low for a given incidence, due to an intense local meteorological phenomenon. The detection may be carried out on the basis of a single inconsistent parameter or a single inconsistent flight condition, with respect to the normal flight envelope of the aircraft and the peripheral flight envelope of the aircraft 100, but also on the basis of a combination of one or more inconsistent flight parameters and/or one or more inconsistent flight conditions with respect to the normal flight envelope of the aircraft 100 and the peripheral flight envelope of the aircraft 100. In the absence of detection of an unusual attitude of the aircraft 100 (step S2, “no” status), the configuration of the flight-command laws remains unchanged and the method loops back to step S1. Otherwise, if it is estimated that the flight of the aircraft 100 no longer conforms to its normal flight envelope, or even to its peripheral flight envelope (step S2, “yes” status), the information obtained from the sensors and/or computers Se1, Se2, Se3, . . . , Sen is adapted during a step S3 so as to check the consistency thereof with respect to the values normally possible and/or expected, so as to then carry out, or at the very least attempt to then carry out, during a step S4, automated control of the flight commands of the aircraft 100 on the basis of this adapted information. The concept of adaptation described here should be interpreted as analysis of the measured or simply obtained values with respect to values normally possible or conceivable for each of the quantities shown (therefore by each of the sensors and/or computers Se1, Se2, Se3, . . . , Sen) and the replacement of one or more values which are deemed to be unsuitable or inconsistent, each with a substitution value, in the event of a value which is deemed inconsistent. During a step S5, it is verified whether the flight is still being carried out outside the normal flight envelope of the aircraft 100 and outside the peripheral flight envelope of the aircraft 100. If this is the case (step S5, “yes” status), the method loops back to step S3 in order to continue carrying out flight commands which aim to recover the aircraft 100 into its peripheral flight envelope and ideally into its normal flight envelope.

If, on the contrary, the flight commands carried out in step S4 were of a nature to recover the aircraft 100 into its peripheral flight envelope or ideally into its normal flight envelope (step S5, “no” status), then the method loops back to step S1 and the rest of the flight of the aircraft 100 is again carried out according to normal command laws.

The upset-recovery method described in relation to FIG. 3 advantageously makes it possible, by virtue of its execution in the flight-command controller device 1, to perform a sequence of upset-recovery flight commands which aim to bring the aircraft 100 out of flight conditions which no longer satisfy the desired retention of the safety of its flight and of its integrity.

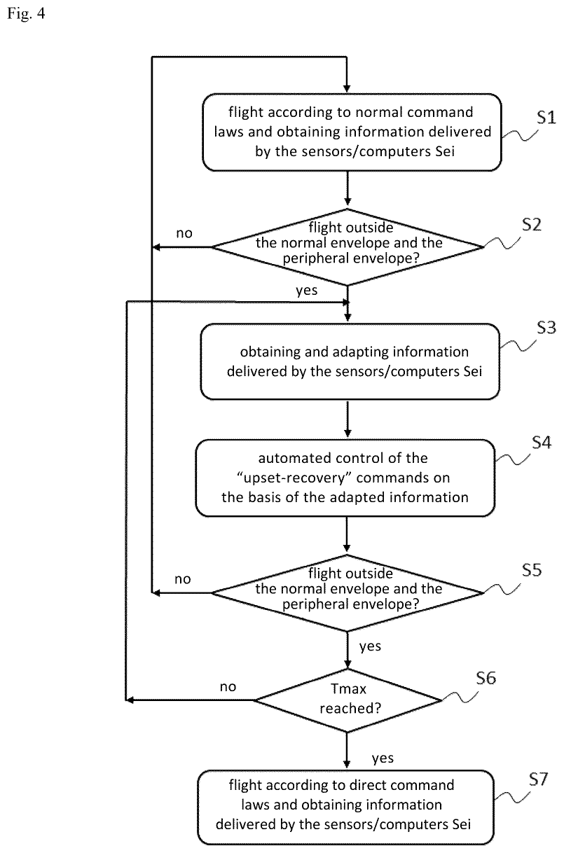

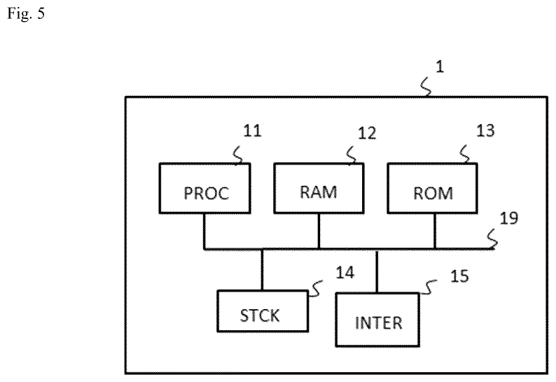

FIG. 4 illustrates a variant of the method already described with respect to FIG. 3. Additional steps S6 and S7 are implemented subsequently to step S5 when it is detected in step S5 that the carried-out flight of the aircraft 100 has not been able to be recovered into the normal flight envelope, or into the peripheral flight envelope of the aircraft 100. Specifically, during a step S6, it is determined by the flight-command controller device 1 whether the time elapsed since a first detection carried out in step S2 of a flight of the aircraft 100 outside its normal flight envelope and outside its peripheral flight envelope is greater than or equal to a predetermined maximum duration Tmax. According to one embodiment, the maximum duration Tmax is between fifteen seconds and sixty seconds. According to a preferred embodiment, the maximum duration Tmax is between twenty and forty seconds. Ideally, the maximum duration Tmax is equal to thirty seconds. Ingeniously, the maximum duration Tmax is used as a temporal threshold beyond which (if a time Tmax is reached), if the automated control of the flight commands which is carried out iteratively during steps S3 and S4 has not resulted in the flight of the aircraft 100 being recovered into its normal flight envelope or into its peripheral flight envelope, the flight-command control device 1 is then configured during a step S7 to operate according to direct laws of flight commands and the flight is then carried out on the basis of piloting performed by a human pilot. Otherwise, that is to say if the time elapsed since a first detection carried out in step S2 of a flight of the aircraft 100 outside its normal flight envelope and outside its peripheral flight envelope has not reached the maximum duration Tmax, the method then loops back to step S3 in order to continue automated control of the flight commands which aim to automatically recover the flight of the aircraft 100 into its normal flight envelope or at the very least into its peripheral flight envelope. This implies here the triggering of a time counter from zero upon detection of a first detection carried out in step S2 of a flight of the aircraft 100 outside its normal flight envelope and outside its peripheral flight envelope.

FIG. 5 is a schematic representation of an example internal architecture of the flight-command controller device 1. By way of illustration, FIG. 5 will be considered to illustrate an internal arrangement of the flight-command controller device 1 such as the aircraft 100 has on board. It is noted that FIG. 5 may also schematically illustrate an example hardware architecture of the module for managing one or more sticks PS or of the autopilot module AP, or of any one of the sensors and/or computers Se1, Se2, Se3, . . . Sen, or else of any one of the flight-command or control-surface actuators A1, A2, A3, . . . An. In the hardware-architecture example shown in FIG. 5, the flight-command controller device 1 then comprises, connected by a communication bus 19: a processor or CPU (acronym of Central Processing Unit) 11; a random-access memory (RAM) 12; a read-only memory (ROM) 13; a storage unit such as a hard disk (or a storage-medium reader such as an SD card reader (SD standing for Secure Digital)) 14; a communication-interface module 15 allowing the flight-command controller device 1 to communicate with remote devices, such as other systems on board the aircraft 100.

The processor 11 of the flight-command controller device 1 is capable of executing instructions loaded into the RAM 12 from the ROM 13, from an external memory (not shown), from a storage medium (such as an SD card), or from a communication network. When the flight-command controller device 1 is powered up, the processor 11 is capable of reading instructions from the RAM 12 and of executing them. These instructions form a computer program which causes the processor 11 of the flight-command controller device 1 to implement all or part of an upset-recovery method for recovering the flight into a normal flight envelope or into a peripheral flight envelope described in relation to FIG. 3, or described variants of this method, such as, by way of example, the variant described in relation to FIG. 4.

All or part of the method described in relation to FIG. 3 or FIG. 4 or its described variants may be implemented in software form through execution of a set of instructions by a programmable machine, for example a digital signal processor (DSP) or a microcontroller, or may be implemented in hardware form by a dedicated machine or component, for example a field-programmable gate array (FPGA) or an application-specific integrated circuit (ASIC). In general, the flight-command controller device 1 comprises electronic circuitry configured to implement the method described in relation thereto. Of course, the flight-command controller device 1 further comprises all the elements that are usually present in a system comprising a control unit and its peripherals, such as, a power-supply circuit, a power-supply-monitoring circuit, one or more clock circuits, a zeroing circuit, input/output ports, interrupt inputs, and bus drivers, this list being non-exhaustive.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An upset-recovery method for recovering an aircraft in flight into a first predefined flight envelope called a normal flight envelope, the method being executed in a flight-command control device and the method comprising:
recurringly obtaining first information coming from sensors and/or one or more computers of the aircraft, which are configured to deliver information representative of flight conditions or parameters of the aircraft;
detecting one or more flight conditions or parameters of the aircraft outside a second flight envelope of the aircraft, called a peripheral flight envelope, which is broader than the normal flight envelope and surrounds the normal flight envelope;
adapting the first information, the adapting comprising:
comparing each item of the first information with a predetermined range of acceptable values which is defined in relation to a nature of information in question; and
replacing the information in question with a substitution value when the information in question is outside the range of acceptable values;
automated control of flight commands of the aircraft based on the adapted information, so as to recover the flight of the aircraft into the normal flight envelope.

2. The upset-recovery method of claim 1, according to which the substitution value is a last value measured prior to the detecting of one or more flight conditions or parameters outside the peripheral flight envelope, for the information in question.

3. The upset-recovery method of claim 1, wherein the automated control of flight commands is carried out for a predetermined maximum duration from detecting one or more flight conditions or flight parameters of the aircraft outside the second flight envelope of the aircraft.

4. The method of claim 3, wherein the aircraft is automatically configured into a direct-law flight-command mode at an end of the maximum duration if the aircraft is not recovered into the normal flight envelope or the peripheral flight envelope.

5. A device for controlling flight commands of an aircraft, the control device comprising electronic circuitry configured to:
recurringly obtain first information coming from sensors and/or one or more computers of the aircraft, which are configured to deliver information representative of one or more flight conditions or flight parameters of the aircraft;
detect one or more flight conditions or flight parameters of the aircraft outside a second flight envelope of the aircraft, called a peripheral flight envelope, which is broader than a first flight envelope, called a normal flight envelope, and surrounds the normal flight envelope;
carry out adaptation of the first information, the adaptation comprising:
comparing each item of the first information with a predetermined range of acceptable values which is defined in relation to a nature of information in question; and
replacing the information in question with a substitution value when the information in question is outside a range of acceptable values;
carry out automated control of flight commands of the aircraft based on the adapted information, so as to recover the flight of the aircraft into the normal flight envelope.

6. The flight-command control device of claim 5, further comprising electronic circuitry configured to define the substitution value as being a last value measured prior to the detecting one or more flight conditions or flight parameters outside the peripheral flight envelope, for the information in question.

7. The flight-command control device of claim 5, further comprising electronic circuitry configured so that the automated control of flight commands is carried out for a predetermined maximum duration from the detecting one or more flight conditions or flight parameters of the aircraft outside the second flight envelope of the aircraft.

8. The flight control device of claim 7, further comprising electronic circuitry configured to automatically configure the aircraft into a direct-law flight-command mode at an end of the maximum duration if the aircraft is not recovered into the normal flight envelope or the peripheral flight envelope.

9. An aircraft comprising at least one flight-command control device of claim 5.

10. A computer program product comprising program code instructions for executing the method of claim 1 when the program is executed by a processor of a device for controlling flight commands of an aircraft.

11. A storage medium comprising the computer program product of claim 10.
